(19) United States
(12) Patent Application Publication
(10) Pub. No.: US 2001/0030876 A1
(43) Pub. Date: Oct. 18, 2001

(54) Self-cleaning automotive head lamp

(76) Inventors: Ing-Feng Hu, Midland, MI (US); Paul J. O'Connor, Midland, MI (US); Yi-Hung Chiao, Pasadena, CA (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/729,490

(22) Filed: Dec. 4, 2000

Related U.S. Application Data
(60) Provisional application No. 60/169,027, filed on Dec. 3, 1999.

(51) Int. Cl. F21V 15/01; B08B 7/00

(52) U.S. Cl. 362/546; 362/362; 134/4; 106/3

(57) ABSTRACT

A self-cleaning automotive head lamp, wherein the inner surface of the lens has applied to it an amphiphilic coating containing a photocatalyst.

### CROSS-REFERENCES TO RELATED APPLICATIONS

This application claims benefit of U.S. Provisional Application Ser. No. 60/169,027, filed Dec. 3, 1999.

The present invention relates to automotive head lamps. More specifically, the present invention relates to automotive head lamps having the interior side of the lens coated with an amphiphilic surface that helps prevent the surface from accumulating undesirable contaminants such as oil, water, and organic impurities.

### BACKGROUND OF THE INVENTION

A long-standing problem in the auto industry has been the safety hazards that can be created as automobile head lamps get dirty. If a head lamp gets sufficiently dirty, the dirt can block much of the lighting, resulting in a safety hazard. Of course, the outside of an automobile head lamp can be easily cleaned whenever it gets dirty.

Historical automobile headlamps of a ‘sealed-beam’ type completely enclosed the lamp, the reflector, and the lens in a single glass enclosure. More recent auto headlamp designs incorporate a separate lamp of perhaps a quartz type inserted in an opening in a polymeric reflector and polymeric lens. During the cooling cycle of a hot headlamp which has been in use, air and the contents of air which cause the headlamp to foul migrate inside the headlamp by the partial vacuum caused by the cooling of the headlamp from the surrounding atmosphere. When a hot automobile is turned off, nearby the headlamp is a heated engine which is replete as a source of a variety of organic vapors. The heat generated by a subsequent headlamp use can cause the organic content of the headlamp space to deposit as a form of soot on the reflector and lens of the headlamp.

The inside of the head lamp, in contrast to the outer headlamp lens surface, cannot be easily cleaned. If the inside of the head lamp gets sufficiently dirty to create a safety hazard, the entire head lamp must be replaced to alleviate the safety hazard.

Photocatalytic processes are known. U.S. Pat. No. 5,874,701 teaches photocatalytic treatment of airborne indoor contamination. Indeed, it is suggested that photocatalysis may be useful to remove airborne contamination in a sterile hospital environment.

Photocatalysis principles are explained in the U.S. Pat. No. 5,874,701 reference as occurring when a semiconductor photocatalyst absorbs light energy (hν) higher than the band gap energy (E.g.) of the semiconductor, the electrons in the valance band are photoexcited and raised into the conduction band to produce electron-hole pairs (e⁻-h⁺) at the surface layer of the semiconductor.

hν→e⁻-h⁺

The U.S. Pat. No. 5,874,701 reference reports a belief that in photocatalytic decomposition of compounds, holes h⁺ and electrons e⁻ generated by photoexcitation of semiconductor photocatalyst serve to oxidize and reduce surface hydroxyl group and surface oxygen, respectively, to generate OH radical (OH) and superoxide ion (O₂⁻)

OH⁻=h⁺→OH

O₂+e⁻→O₂⁻

These species are highly active and induce redox process of the compounds. It is considered that photodecomposition of a compound is a multiple electron process. Thus, the original species is transformed through a plurality of intermediates into final products.

The U.S. Pat. No. 5,874,701 reference disclosed that photocatalytic processes do not require the high intensity light source in the ultra-violet frequency range according to the prior art. Rather, sufficient UV radiation is emitted from ambient lighting a sufficient, though small amount of energy greater than the band gap energy of semiconductor photocatalysts. Consequently, general application electric lighting may be used for photoexcitation of photocatalysts.

### SUMMARY OF THE INVENTION

It has been discovered that coatings containing a photo-catalyst as may be suitable for room sterilization, fog free optical glasses, fog free mirrors, may be applied to the inside surface of a head lamp to help keep the lens and reflector clean. Accordingly, in one aspect the present invention is a head lamp having the inner surface of the head lamp coated with a layer containing a photocatalyst. The light from the head lamp photoexcites or activates the photocatalyst.

### DETAILED DESCRIPTION OF THE INVENTION

Photocatalyst-containing coatings that are useful in the present invention are taught in U.S. Pat. No. 5,939,194 issued to Hashimoto et al. (“Hashimoto”), the teachings of which are herein incorporated by reference. Hashimoto teaches that surfaces coated with a photocatalyst-containing layer can be easily cleaned. More specifically, Hashimoto teaches that deposited oil can be easily removed by rinsing the surface with a large amount of water and that water deposited on the surface can be removed by rinsing the surface with a large amount of an oil solvent. Thus, Hashimoto teaches that photocatalyst-containing coatings can be advantageously used on surfaces to make them easier to clean. Hashimoto teaches that these coatings can be advantageously used on the exterior of buildings, the exterior of vehicles, and the exterior of machinery and articles, etc.

A limitation of the prior art is that useful forms of the photocatalyst are taught as being sintered on inorganic substrates such as glass at temperatures near 500° C., far in excess of the glass transition temperature, T_{g}, of polymers in present use as automotive headlamps. See Examples of EP 0 816 466 A1.

To be useful as a photocatalytic cleaner of headlamp lenses and reflectors, a semi-conductor based photocatalytic surface must be provided to the thermoplastic headlamp components by means which does not destroy by excessive heat the thermoplastic headlamp unit. The inventors have identified such a process as explained herein.

Surprisingly, it has been found that these photocatalyst-containing coatings can be advantageously utilized on the interior of automotive head lamps. When utilized in this manner, these coatings help prevent the inside surface from becoming dirty. The light from the head lamp is sufficient to photoexcite the photocatalyst so as to reduce or eliminate the accumulation of contaminants such as oil, water, grease, and organic impurities on the surface.

The useful semi-conductor materials suitable as photocatalysts include oxides of zinc, iron, bismuth, tungsten, aluminum, and titanium. Other useful catalyst components include platinum, palladium, ruthenium, rhodium, iridium, and osmium.

The catalyst components are advantageously incorporated in a coating composition. Sol-gel coatings in which an inorganic component, cross-linker and photocatalyst are combined are convenient vehicles for depositing the photocatalyst on the surface of the headlamp, and preserving the position of the photocatalyst in place. Suitable sol-gel compositions may be prepared from readily available silicasols and a suitable cross-linking agent such as an organic epoxide such as diglycidal ether of bisphenol A, or preferably a functionalized cross-linking silane such as 3-glycidoxypropyl-trimethoxysilane.

Useful cross-linkers for aqueous solutions of the present invention are hydroxy functionalized silanol, acid hydrolyzed epoxy silanol, acid hydrolyzed epoxies, epoxy-amine adducts, hydroxy-containing acrylates, hydroxy-containing urethanes, hydroxy-containing epoxies, ethoxide-containing acrylates, ethoxide-containing urethanes, and ethoxide-containing epoxies.

The amount of organic cross-linker present in solutions of the present invention should be measured relative to the amount of inorganic phase present and not measured relative to the total solution. The cross-linker should comprise no more than about 70 weight percent of the combined weights of the inorganic particles including the semi-conductor/ photocatalyst, and the organic cross-linker. Generally, the cross-linker will comprise at least about 25 weight percent of the combined weights of the inorganic particles and the organic cross-linker.

The photocatalyst particle size is preferably sufficiently small so as to not obstruct the passage of visible light either through the headlamp lens, or as reflected light passes through the coating to the reflective surface, then back through the coating to exit the lens. Particle sizes permitting light passage should be less than 100 nm, preferably less than 50 nm, more preferably less than 40 nm, still more preferably 30 nm.

Alternatively, the photocatalyst may be deposited on the headlamp surface by means of chemical vapor deposition (CVD) of a composition of predominantly an organosilane, siloxane or silazane which are liquid at ambient temperature and pressure, including: methylsilane, dimethylsilane, trimethylsilane, diethylsilane, propylsilane, phenylsilane, hexamethyldisilane, 1,1,2,2-tetramethyl disilane, bis(trimethylsilyl)methane, bis(dimethylsilyl) methane, hexamethyldisiloxane, vinyl trimethoxy silane, vinyltriethoxy silane, ethylmethoxy silane, ethyltrimethoxy silane, divenyltetramethyldisiloxane, divinylhexamethyltrisiloxane, and trivinylpentamethyltrisiloxane, 1,1,2,2-tetramethyldisiloxane, hexamethyldisiloxane, vinyltrimethylsilane, methyltrimethoxysilane, vinyltrimethoxysilane and hexamethyldisilazane. Preferred silicon compounds are tetramethyldisiloxane, hexamethyldisiloxane, hexamethyldisilazane, tetramethylsilazane, dimethoxydimethylsilane, methyltrimethoxysilane, tetramethoxysilane, methyltriethoxysilane, diethoxydimethylsilane, methyltriethoxysilane, triethoxyvinylsilane, tetraethoxysilane, dimethoxymethylphenylsilane, phenyltrimethoxysilane, 3-glycidoxypropyltrimethoxysilane, diethoxymethylpehnylsilane, tris(2-methoxyethoxy)vinylsilane, phenyltriethoxysilane and dimethoxydiphenylsilane.

Generation of a plasma CVD of the invention may occur by known methods: electromagnetic radiation of radio frequency, microwave generated plasma, AC current generated plasma as are taught in U.S. Pat. Nos. 5,702,770; 5,718,967, and EP 0 299 754, DC current arc plasma is taught by U.S. Pat. No. 6,110,544. Magnetic guidance of plasma such as is taught in U.S. Pat. No. 5,900,284. For plasma generated coatings on the inside surface of a nearly enclosed space, such as a container, plasma may be generated within the container similar to the teachings of U.S. Pat. No. 5,565,248 which is limited to inorganic sources of plasma for coatings including silicon. Further, the magnetic guidance of plasma as taught in U.S. Pat. No. 5,900,284 may be wholly within a nearly enclosed space such as a headlamp unit, or a container, or optionally magnetic guidance and a plasma generating electrode may be wholly within a container. Magnetic guidance of plasma for a barrier coating on the inside surface of a container may also be provided by magnetic guidance wholly outside a headlamp unit or container and optionally with plasma generating electrode(s) within the headlamp unit or container. Magnetic guidance of plasma for a barrier coating on the inside surface of a headlamp unit or container may also be provided by magnetic guidance, partially within a headlamp unit or container and partially outside a headlamp unit or container. Optionally, for the case of magnetic guidance of plasma for a barrier coating on the inside surface of a headlamp unit or container, where partial magnetic guidance is provided within the headlamp unit or container, a plasma generating electrode may also be included within the headlamp unit or container, as may a source for the plasma reactant, a silane.

A headlamp substrate on which a CVD plasma coated photocatalyst may deposited include glass and organic polymers including polyolefins and co-polymers of polyolefins such as polyethylene, polypropylene, poly-4-methylpentene-1, polyvinylchloride, polyethylene napthalate, polycarbonate, polystyrene, polyesters such as polyethylene terephthalate and polybutylene terephthalate, polyurethanes, polybutadienes, polyamides, polyimides, fluoroplastics such as polytetrafluorethylene and polyvinylidenefluoride, cellulosic resins such as cellulose proprionate, cellulose acetate, cellulose nitrate, acrylics and acrylic copolymers such as acrylonitrile-butadiene-styrene, chemically modified polymers such as hydrogenated polystyrene and polyether sulfones.

In the generation of the plasma, the photocatalyst is conveniently presented in a liquid form: for example, an organotitanate such as tetraethoxytitanium, tetramethoxytitanium, tetrapropoxytitanium or tetrabutoxytitanium may be introduced into the plasma either with the organosilicon, or separately metered into the plasma. Alternately, a titanium acetate, or a chelate of titanium in a solvent of alcohol such as ethanol, a propanol, or a butanol may be metered into the plasma.

The photocatalyst (titanium or other semi-conductor) should be added to the plasma at a rate sufficient to deposit from 0.1, preferably not less than one (1) part, to 10 parts, preferably not more than 6 parts, photocatalyst based on the weight of the catalyst to 100 parts of the plasma deposited coating, of the photocatalyst.

Coatings useful in the present invention can be advantageously applied to both the inner surface of a head lamp lens or the inner reflective walls of the head lamp housing. The surfaces to be coated can be made of either plastic or glass. Polymers having application to headlamp units include polycarbonate, polyethersulfone, styrene and acryaltes and combinations thereof, including ABS (acrylonitrile-butadiene-styrene co-polymer). Head lamp housings that can be advantageously coated also include those made of plastics metallized with light reflecting and focusing coatings, such as those containing aluminum.

Useful coatings can be applied directly to the interior surface of the head lamp or can be applied on top of other coatings that provide additional functionalities. These other coatings can include scratch-resistant coatings, weather-resistant coatings, and adhesion-promoting coatings.

### EXAMPLE 1

A polymeric headlamp unit comprising a unitary lens and reflector having an opening in the reflector for insertion and affixing a lamp, preferably of a quartz type, serves as a support for a photocatalytic coating. The polymer is a polycarbonate.

A sol of a photocatalyst is prepared for coating on the headlamp unit. A sol-gel is prepared from 15 parts on the basis of SiO₂ of a silical sol available under the name Ludox-TMA from E. I. DuPont de Nemours, Co. Wilminton Del. 19898, United States comprising 34 percent colloidal suspension in water having a pH from 4 to 7, a particle size of 22 nm, a negative particle charge, and a specific surface area of 140 m²/g. Four parts of titanium oxide in the form of TiO₂ powder of the anatase form of TiO₂. An aqueous solution of 4% ammonia and anatase TiO₂ having a particle size of 10 nm may be obtained from K.K. Taki Chemical, Kakogawa-shi, Hyogo-ken, Japan. Twenty-five parts of a cross-linker of 3-glycidoxypropyltrimethoxy-silane (available commercially as Z-6040 from Dow Corning Corporation Midland, Mich. 48640 United States). The remainder of the composition to make 100 parts comprises water.

The mixture is mixed sonically such as with a VibraCell 700 Watt ultrasonic horn sold by Sonics and Materials, 53 Church Hill Rd, Newtown Conn. 06470 United States at thirty percent amplitude for 3 minutes.

After allowing the sol to stand for 3 hours, the coating is applied to the interior surface of a corona treated polycarbonate headlamp unit. Apparent moisture is dried by moderate heat below 90° C., then the dried coating is cured in an oven at 120° C. for 45 minutes.

Cooled headlamps are installed on one side of an automobile for evaluation of clarity. A second cleaned headlamp unit is installed on the other side of the automobile. After a period of use on an automobile, the coated headlamp is removed and compared to a non-coated headlamp unit. The coated headlamp unit is noticeably clearer. Upon separating the lens from the reflector of each headlight unit by sawing, noticeable clarity is observed in both the reflector and the lens of the coated headlamp as compared to the uncoated headlamp.

### Example 2

A three-dimensional headlamp unit is placed in a vacuum chamber with microwave-frequency plasma generating source. The plasma system is designed to generate a plasma substantially in the interior volume of the headlamp. An organosilane reactant gas of tetramethyldisiloxane (TMDSO) is admitted to the chamber at the rate of 15 sccm. Plasma is generated with 5×10⁸ J/kg power density for 45 seconds generating a condensed-plasma coating of about 0.05 μm thickness on the interior surface of the container. A second condensed-plasma layer is formed by adding tetraethoxytitanium at 4 sccm to the vacuum chamber. TMDSO is increased from 15 sccm to 45 sccm linearly over 3 minutes, then held constant until a condensed-plasma layer of 500 Å is deposited on the interior surface of the headlamp. The power density is 1.5×10⁸ J/kg. A clear colorless condensed-plasma coating on the interior surface of the headlamp results. Upon evaluating the headlamp on an automobile with a control headlamp having a plasma deposited layer without the semiconductor photocatalyst layer results similar to Example 1 are observed.

What is claimed is:

1. An automotive headlamp unit comprising a transparent coating on the interior of the headlamp unit of a photocatalytic semi-conductor.

2. The automotive headlamp unit of claim 1 wherein the headlamp unit comprises glass.

3. The automotive headlamp unit of claim 1 wherein the headlamp unit comprises a plastic.

4. The automotive headlamp unit of claim 3 wherein the plastic comprises polycarbonate, polyethersulfone, styrene, acryaltes, acrylonitrile-butadiene-styrene co-polymer.

5. The automotive headlamp unit of claim 1 wherein the transparent coating is deposited as a sol-gel.

6. The automotive headlamp unit of claim 1 wherein the transparent coating is deposited from a condensed plasma.
